(19) United States
(12) Patent Application Publication
(10) Pub. No.: US 2005/0253498 A1
(43) Pub. Date: Nov. 17, 2005

(54) Frame section for a cathode ray tube

(76) Inventors: Ludovic Peter Willem Huysmans, Eindhoven (NL); Franciscus Henricus Josephus Simkens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/525,576

(22) PCT Filed: Jul. 31, 2003
(86) PCT No.: PCT/IB03/03715

§ 371 Date: Feb. 23, 2005

(30) Foreign Application Priority Data
Aug. 28, 2002 (EP) 02078533.3

(51) Int. Cl. H01J 29/80

(52) U.S. Cl. 313/402

(57) ABSTRACT

The present invention relates to a frame section (1) and a method for uncoupling at least a part of a reinforcing flange (5) from the rest of the frame section, a shadow mask frame and a shadow mask (4) in a cathode ray tube. The shadow mask frame is composed of at least four frame sections arranged in a hollow, generally rectangular shape, and each frame section includes two flange portions (2, 5) of a thin-walled material arranged at an angle to each other. A first flange portion serves as a mask mounting flange (2) the width of which extends generally in parallel with the cathode rays, and a second flange portion serves as a reinforcing flange (5) whose width extends generally perpendicularly to the cathode rays. According to the invention, a through-slit (6) is formed in the longitudinal direction of the frame section.

The present invention relates to a frame section adapted to form part of a shadow mask frame, within a cathode ray tube, having a hollow, generally rectangular shape and on which a shadow mask is mountable, said frame section including two flange portions of a thin-walled material arranged at an angle to each other, a first flange portion serving as a mask mounting flange the width of which extends generally in parallel with the direction of the cathode rays and on which the shadow mask is mountable, and a second flange portion serving as a reinforcing flange having its width extended generally perpendicularly to the direction of the cathode rays.

The invention also relates to a cathode ray tube comprising a color selection electrode with a frame including a frame section as indicated above.

In color cathode ray tubes, for e.g. television sets or computer monitors, it is a well known problem that the quality of the image deteriorates when the cathode ray tube is exposed to environmental vibration sources such as loud sounds, from e.g. speakers, or impacts. The picture resolution and the color purity degrade. The reason for this is that the shadow mask begins to oscillate when exposed to environmental vibrations, the so-called microphony effect or behavior, as a result of which the cathode rays frequently impinge on the wrong spots of the image screen.

In recent years it has become more common to manufacture cathode ray tubes of shorter lengths, i.e. “flatter” tubes, in which the cathode rays are spread at a wider angle. Concurrently with this tendency, it has been observed that the problem with microphony behavior of the cathode ray tubes has increased.

In JP 6-44919 A there is disclosed a shadow mask body structure in which attempts have been made to solve the problems related to microphony behavior of the shadow mask by forming a pattern of horizontal and vertical beads on the body structure. These measures make the body structure more stable and rigid, but the area susceptible to environmental vibrations is still the same and the effect of these measures is that the resonance frequency of the body structure is raised.

It is an object of the present invention to provide a frame section which reduces the susceptibility of the shadow mask to oscillations due to environmental vibrations. At least this object is achieved by a frame section according to claim 1.

According to alternative embodiments of the invention, in respect of claim 6, there is provided a frame section which, in accordance with a further object, has an increased stability and rigidity.

Accordingly, the invention is based on the insight that the above-mentioned objects can be achieved by providing a through-slit in the longitudinal direction of the reinforcing flange of the frame section. By this measure a large part of the area of the reinforcing flange, which is unfavorably affected by the environmental vibrations, can be uncoupled from the rest of the frame section, the frame and the shadow mask, and can oscillate independently without adversely affecting the shadow mask. Simultaneously the resonance frequency of the frame section is lowered, as a result of which the environmental vibration frequency, which affects the frame section most, can be lowered to a frequency below the audible frequency, if desired. Thus, the frequencies below a frequency slightly above the resonance frequency can be filtered out of the soundtrack of a program without audibly affecting the sound.

The length of the slit can be varied in dependence on the actual situation, e.g. the width of the reinforcing flange portion or the resonance frequency of the frame and the shadow mask. Generally the length of the slit is at least 50%, preferably at least 60% and most preferably at least 70%, of the total length of the frame section. Furthermore, it is conceivable that more than one slit is formed in one and the same frame section if this has proved to be advantageous. It is preferred that a slit is continuous throughout its length. However, it would be possible to achieve the desired advantages with a slit interrupted by bridging portions. By varying the slit length, the number of slits or the position of the slit in the reinforcing flange portion, it is possible to “tune” the frame section, the assembled frame as well as the combination of frame and shadow mask to fade out a specific frequency or range of frequencies.

The frame sections making up the shadow mask frame can optionally be formed as separate sections which are subsequently assembled into the shadow mask frame. However, all the frame sections for a shadow mask can also be formed from a common blank which is bent and formed into the desired form of the shadow mask frame. It is also within the scope of the invention that only one, or a few, the frame sections making up the shadow mask frame can be formed with a slit.

According to an alternative embodiment of the invention, the slit in the reinforcing flange portion is combined with a bead or rib on the part of the reinforcing flange that is closest to the free inner edge of the frame section in relation to the slit. Preferably, the rib is formed by corrugating the reinforcing flange, and it extends parallel to the slit. Like the slit, the rib can be varied in length, position and number, and can be utilized to “tune” the frame section.

The invention will now be explained by way of example with reference to the accompanying drawings in which:

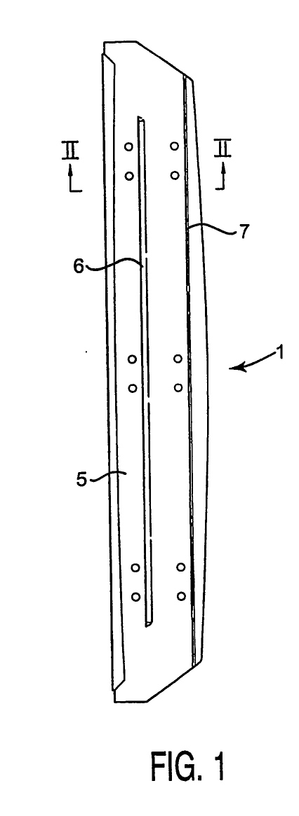

FIG. 1 is a plan view of a frame section according to the invention, seen from the side of the reinforcing flange.

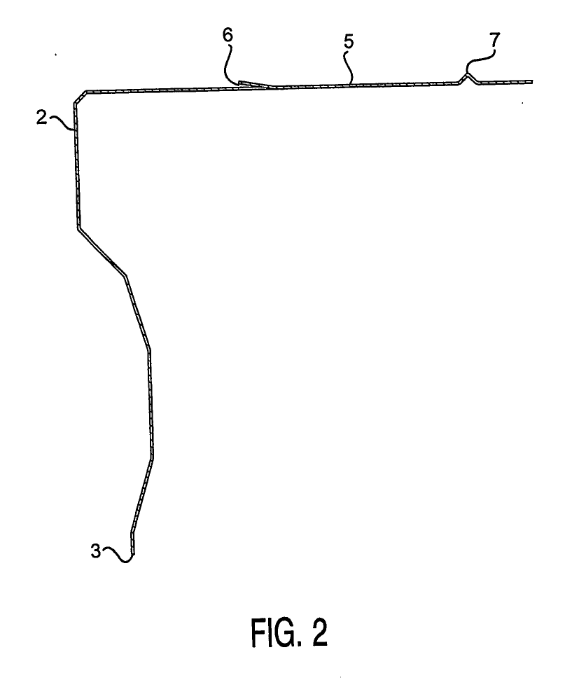

FIG. 2 is a cross sectional view along line II-II in FIG. 1.

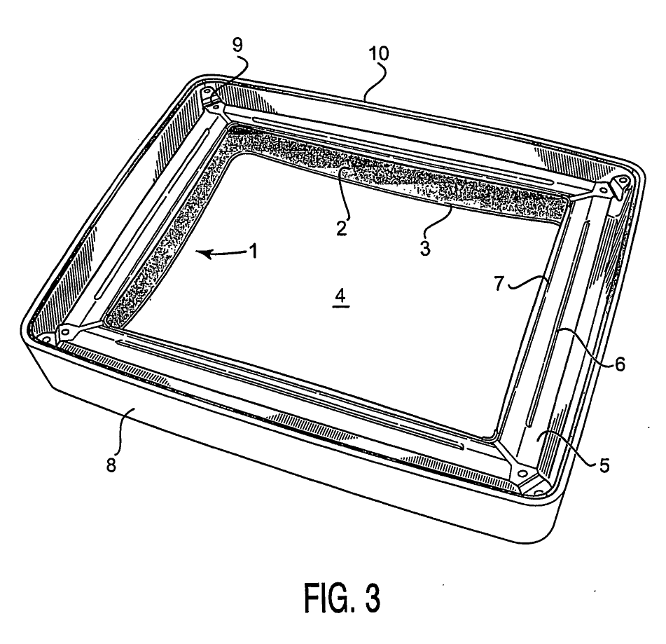

FIG. 3 is a perspective view of an assembled shadow mask frame inserted in a front portion of a cathode tube envelope.

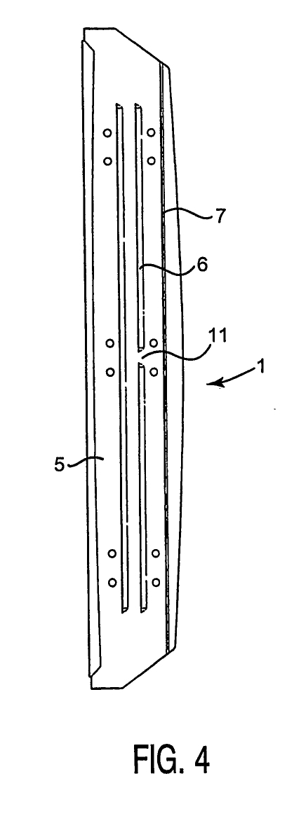

FIG. 4 is a plan view corresponding to FIG. 1 of an alternative embodiment.

In FIGS. 1 and 2 is shown a frame section 1 according to the invention in a plan view and a cross-sectional view, respectively. In the preferred embodiment, the frame sections are manufactured as separate parts, of which four frame sections are assembled into a rectangular shadow mask frame which is hollow in the center for the cathode rays. Each frame section includes a mask mounting flange 2, which can be designed in a number of different ways. In accordance with the general principle, the width of the mask mounting flange in the completed cathode ray tube will extend essentially in parallel with the cathode rays and with an outer edge portion 3 directed towards the image screen of the cathode ray tube. The outer edge portion 3 of the mask mounting flange defines a double curved mounting surface for mounting of a shadow mask (at 4 in FIG. 3) so that it adopts the correct position and form.

Essentially perpendicular to the mask mounting flange, the frame section is formed with a reinforcing flange 5 which, in the completed cathode ray tube, is positioned with its width essentially perpendicular to the cathode rays. The reinforcing flange 5 has a straight slit 6 as well as a straight rib 7 which both are extended in the longitudinal direction of the frame section. The rib 7 is positioned in the area between the slit and the edge portion of the frame section facing away from the mask mounting flange 2, to reinforce and stabilize the area of the frame section which becomes uncoupled from the mask mounting flange through the slit 6.

As is evident from FIG. 2, the slit is formed by a straight cut through the reinforcing flange 5 and, subsequently, one of the edge portions adjacent the through cut is bent outward. The rib 7 is formed through a corrugation or fold in the reinforcing flange 5.

In FIG. 3, the shadow mask frame is shown in the assembled condition of four individual frame sections 1 and positioned in a front portion of a tube envelope 8 which, on the inner side, is provided with an image screen layer. The frame sections 1 form a rectangular frame with a hollow center and the respective mask mounting flanges 2 are directed towards the image screen layer on the inside of the front portion of the tube envelope. A shadow mask 4 is mounted on the edge portions 3 of the mask mounting flange 2. The reinforcing flanges 5 of each frame section 1 are directed inward toward a rectangular opening enclosed by the frame sections. The uncoupling slit and the stabilizing rib are shown at 6 and 7, respectively. The individual frame sections are joined together and fastened to the tube envelope by means of fittings 9 in each corner of the shadow mask frame. The front portion of the tube envelope, with the shadow mask frame assembly therein, is eventually hermetically joined to a cone portion of the tube envelope along a rim 10 of the front tube envelope.

In FIG. 4 is shown an alternative embodiment of a frame section 1 according to the invention. In this embodiment there are arranged two slits 6 in parallel with each other, and one of the slits 6 is interrupted by a bridging portion 11. The embodiment is just an example of how the frame section according to the invention may be varied to “tune” the frame section in a desired way to achieve the best possible performance of the cathode ray tube.

In summary, the present invention relates to a frame section 1 and a method for uncoupling at least a part of a reinforcing flange 5 from the rest of the frame section, a shadow mask frame and a shadow mask 4 in a cathode ray tube. The shadow mask frame is composed of at least four frame sections arranged in a hollow, generally rectangular shape, and each frame section includes two flange portions. 2, 5 of a thin-walled material arranged at an angle to each other. A first flange portion serves as a mask mounting flange 2 the width of which extends generally in parallel with the cathode rays, and a second flange portion serves as a reinforcing flange 5 whose width extends generally perpendicularly to the cathode rays. According to the invention, a through-slit 6 is formed in the longitudinal direction of the frame section.

1. A frame section adapted to form part of a shadow mask frame, within a cathode ray tube, having a hollow, generally rectangular shape and on which a shadow mask is mountable, said frame section (1) including two flange portions (2, 5) of a thin-walled material arranged at an angle to each other, a first flange portion serving as a mask mounting flange (2) the width of which extends generally in parallel with the direction of the cathode rays and on which the shadow mask is mountable, and a second flange portion serving as a reinforcing flange (5) whose width extends generally perpendicularly to the direction of the cathode rays, characterized in that the reinforcing flange portion (5) comprises an elongated through-slit (6) extending in the longitudinal direction of the frame section (1) to reduce the microphony influence on the shadow mask.

2. A frame section according to claim 1, characterized in that the slit (6) has a length of at least 50% of the total length of the frame section (1).

3. A frame section according to claim 1, characterized in that the slit (6) has a length of at least 60% of the total length of the frame section (1).

4. A frame section according to claim 1, characterized in that the slit (6) has a length of at least 70% of the total length of the frame section (1).

5. A frame section according to claim 1, characterized in that the slit (6) is formed as a through-cut in the reinforcing flange (5), and that at least one of the edge portions surrounding the cut is bent on either side so as to misalign the edge portions to form the slit.

6. A frame section according to claim 1, characterized in that the reinforcing flange (5) also comprises a rib which extends (7) in the longitudinal direction of the frame section (1) and is positioned in the area between the slit (6) and an inner edge.

7. A frame section according to claim 1, characterized in that more than one slit (6) are arranged in parallel with each other in the reinforcing flange (5).

8. A frame section according to claim 1, characterized in that the slit (6) is discontinuous along its length and interrupted by a bridging portion (11).

9. A cathode ray tube comprising a color selection electrode with a frame including a frame section (1) according to claim 1.
